(19) United States
(12) Patent Application Publication
(10) Pub. No.: US 2010/0112505 A1
(43) Pub. Date: May 6, 2010

(54) METHOD AND APPARATUS FOR PROCESSING OIL DRILLING WASTE

(75) Inventor: Antero Pulkkanen, Kuusankoshi (FI)

Correspondence Address: MERCHANT & GOULD PC, P.O. BOX 2903, MINNEAPOLIS, MN, 55402-0903, US

(73) Assignee: Migliore Oy, Kuusankoski (FI)

(21) Appl. No.: 12/442,891

(22) PCT Filed: Sep. 25, 2007
(86) PCT No.: PCT/FI2007/050514

§ 371 Date: Jan. 4, 2010

(30) Foreign Application Priority Data
Sep. 25, 2006 (FI) 20060849

(51) Int. Cl. F27B 7/20; F27D 3/00

(52) U.S. Cl. 432/13; 110/346; 432/103; 432/62

(57) ABSTRACT

The invention relates to a method and apparatus for processing oil drilling waste. According to the invention, oil drilling waste of one or more types is selected, and is introduced from the feeding tanks into a rotating kiln; and in the kiln, the oil drilling waste is processed at a temperature of 110 to 13500° C. to form granules having a compact-coated surface.

### FIELD OF THE INVENTION

The invention concerns a method defined in the preamble of claim 1 for processing oil drilling waste as well as an apparatus defined in the preamble of claim 12.

### BACKGROUND OF THE INVENTION

At present, in oil drilling, deeper and deeper drillings are made and often so-called oblique drilling is used, which increases the amount of drilling waste. Furthermore in oil drilling, drilling fluid or lubricant is used, producing contaminated drilling waste that has been previously subjected to centrifuging or, treatment with heat at a temperature of less than 800° C. in order to purify it.

For example, in Norway, where a few percent of the world's oil fields are located, about 50,000 tonnes of oil drilling waste is produced annually.

The oil drilling waste of each object contains rock material and clay material in a ratio typical of each object.

Because environmental regulations are getting stricter, the problem with the prior-art methods is that using the present processing methods of oil drilling waste one cannot obtain a purified product that could be recycled. Using the present methods one has not been able to eliminate the problem with processing a big amount of oil drilling waste.

### OBJECTIVE OF THE INVENTION

The objective of the invention is to eliminate the disadvantages referred to above. One specific objective of the invention is to disclose a new type of method and apparatus for processing the rock and clay-based material produced in oil drilling.

### SUMMARY OF THE INVENTION

The method and apparatus of the invention are characterized by what is presented in the claims.

The invention is based on a method for processing oil drilling waste, especially for its further processing for the purposes of recycling. According to the invention, from one or more drilling objects, oil drilling waste of one or more types is selected, which wastes are introduced into a rotating kiln; in the kiln the oil drilling waste is processed, i.e. burned, at a temperature of 1100 to 1350° C. to form recyclable granules or granulates having a compact-coated, e.g. glazed, surface. In that case, agents harmful to the environment are removed; that is, they transform into another, chemically more harmless form and/or are adsorbed within the granular structure, meaning that the granules are neutralized with respect to the environmental detriments.

At the temperatures in accordance with the invention, a compact-coated surface such as a glazed surface is achieved for the granules.

Typically, oil drilling waste contains a rock derivative/rock derivatives; oil-based drilling fluid known per se; and in some cases also crude oil. The rock derivative may have been chosen from one of the following: illite, chlorite, kaolin, montmorillonite, chalkstone, sandstone, anhydrite, dolomite, calcite, or the like.

In one embodiment of the invention, the oil drilling waste is mixed to form a homogenous mixture prior to introducing into a rotating kiln. Mixing the agents to be processed to form a homogenous mixture prior to a combustion process increases the formation of granules with a uniform composition.

In one embodiment of the invention, the oil drilling waste is processed in the kiln at a temperature of 1120 to 1200° C.

In one embodiment, the oil drilling waste is processed in the kiln at a temperature of about 1130 to 1150° C. In one embodiment, the oil drilling waste is processed in the kiln at a temperature of more than 1150° C. to increase the adherence of the granules to one another.

As the adherence properties increase, the granules can be used e.g. directly in various cast use possibilities, including road soil, soil of storage areas, soil of pipelines, security areas of processes, and basins, or the like.

The oil drilling waste may contain 0 to 100% of rock material and/or 0 to 100% of clay material. In one embodiment, the oil drilling waste contains up to 70 to 100% of rock material and up to 30% of clay material.

In one embodiment of the invention, claybased material is added to the oil drilling waste.

In one embodiment of the invention, clay material such as marine sand is added to the oil drilling waste.

In one embodiment of the invention, water is added to the oil drilling waste. The addition of water facilitates the pumping of the drilling waste. Preferably, the water is removed prior to the combustion or in conjunction with the mixing in a manner known per se, such as by separation by means of density, by sedimentation, centrifuging, or in some other manner.

In one embodiment of the invention, the mixture ratio and/or additives of oil drilling waste of different types is adjusted.

In one embodiment of the invention, the specific weight of the granules produced as a product is adjusted to be in the range 0.3 to 1.5 by changing the mixture ratio of the oil drilling waste of different types. Granules with a low specific weight can be used e.g. for insulation. Correspondingly, granules with a high specific weight can be used e.g. as substitutes for building stone.

The size of the granules to be formed can vary. When desired, the granules can be screened to a desired size distribution for a given use.

In addition, the invention is based on an apparatus for processing oil drilling waste, According to the invention, the apparatus includes one or more feeding tanks; a rotating kiln, into which the oil drilling waste from the feeding tanks is introduced, and in which it is processed at a temperature of 1100 to 1350° C. to form compact-coated granules; and a storage tank, into which the granules from the kiln are stored; the feeding tank, kiln and storage tank are connected to form one whole.

In conjunction with the invention it is possible to use any rotating kiln known in prior art. Preferably, the length of the rotating kiln is so selected that the process of the invention can be performed in the kiln using the desired process parameters, and that round-shaped granules can be formed in the kiln. The rotation speed of the kiln can be used to adjust the size of the granules.

In one embodiment of the invention, the apparatus includes a mixing device for mixing the oil drilling waste from the feeding tanks to form a homogenous mixture.

In one embodiment of the invention, the apparatus includes at least one pump for pumping oil drilling waste, e.g. from the feeding tanks into the rotating kiln or from the feeding tank to the mixing device and/or from the mixing device into the rotating kiln.

In one embodiment of the invention, the apparatus includes at least one conveyor for conveying the oil drilling waste from one part of the apparatus to another, e.g. from the feeding tank into the kiln; from the feeding tank to the mixing device; from the mixing device into the kiln; and/or from the kiln into the storage tank.

In one embodiment, it is possible to use afterburning in conjunction with the processing of oil drilling waste.

In a preferred embodiment, the heat produced in the kiln can be utilized as energy in conjunction with the processing of oil drilling waste, e.g. in conjunction with mixing, burning or the possible drying.

In one embodiment, various devices known per se, e.g. cyclone, exhaust fan, packed scrubber, interface scrubber, fan and/or drift eliminator or a similar device, are used for purifying and/or removing the combustion gases.

In one embodiment of the invention, the apparatus is moveable, which reduces transportation costs. In that case, the processing of oil drilling waste can be implemented near to a place where the oil drilling waste is produced, or near to a place where the granules to be formed are utilized.

In one embodiment of the invention, the apparatus is integrated in conjunction with a vessel. In that case, the feeding tank and the storage tank can be tanks of a vessel and the other parts of the apparatus have been disposed to a suitable place in the vessel. The advantage is that the intermediate costs and therefore the transportation costs are reduced.

The method and apparatus of the invention are suited for processing various kinds of waste produced in oil drilling. The granules being produced can be utilized e.g. like sledgehammer gravel, in earth-moving, road building, as aggregate for building and construction industry, for special purposes, or in a similar manner. Alternatively, the granules can be stored e.g. in an outdoor location or embedded in the sea bottom because due to the compact surface of the granules, there is nothing there to release into the water.

Thanks to the invention, oil drilling waste is transformed into a form that is harmless to the environment.

The invention has the advantage that no additives or clay have to be added to the oil drilling waste for the processing of the invention. However, additives and/or clay can be added when desired.

With the method and apparatus of the invention, producing of granules is very cost-effective. It is possible to dispose of oil drilling waste while obtaining material to be recycled and, as a by-product, energy. The method and apparatus of the invention are very simple, which reduces investment and processing costs. Devices known per se can be used in the apparatus.

The method of the invention is very environmentally friendly and contributes to the principle of sustainable development. Thanks to the invention, a product is obtained which can be made use of as recycled material and which fulfils the tightened environmental regulations.

### LIST OF FIGURES

The invention will now be explained by means of detailed examples of its embodiments with reference to the accompanying drawing, in which

FIG. 1 schematically represents one apparatus in accordance with the invention.

### DETAILED DESCRIPTION OF THE INVENTION

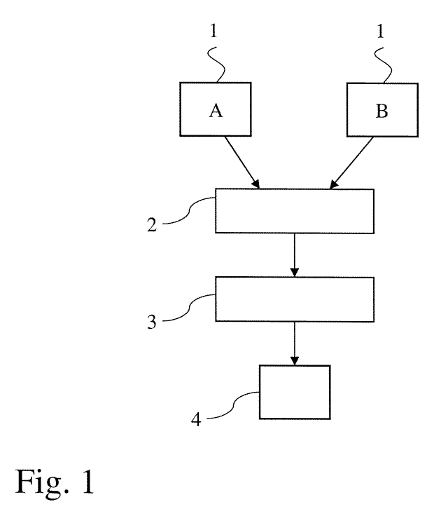

FIG. 1 shows an apparatus of the invention for processing oil drilling waste. The apparatus of the FIGURE comprises two feedings tanks A and B; a mixing device 2 for mixing the oil drilling waste from the feeding tanks 1 to form a homogenous mixture; a rotating kiln 3, into which the homogenous mixture is introduced, and in which the mixture is processed at a temperature of 1100 to 1350° C. to form granules with a compact coating; and a storage tank 4, into which the product from the kiln is stored. The storage tank 1, the mixing device 2, the kiln 3, and the storage tank 4 are connected to form one whole.

### Example 1

The tests of the examples used rock-rich oil drilling waste A from Norway. Part of the tests used, in addition, clay B, which was mixed with A.

In the tests, the materials were plasticized and mixed to form a homogenous mixture using a so-called grain mill 2. The mixture batches were run 1 to 4 times through the mill 2 to obtain a homogenous mixture.

Each sample was 30 kg. The mixture ratios are shown below:
A without plasticization=A0
A mixed=A00
A+B=20%+80%=A20B80
A+B=40%+60%=A40B60
A+B=50%+50%=A50B50
A+B=60%+40%=A60B40
A+B=80%+20%=A80B20

4 pieces of samples were obtained from each mixture. The samples that were mixed to be homogenous were introduced into a rotating kiln 3, which was a pilot kiln with a ratio 1:12. The kiln had a ceramic interior. The temperature was adjusted by means of gas.

Each sample lot was run through a preheated kiln with a dwell time 1 to 1.5 hours. As the combustion temperature, a temperature in the range 1130-1150° C. was used.

As a result of the combustion, round-shaped, compact-coated granules were obtained which were analyzed for detrimental agents, such as heavy metals, and for solubility. It was observed that the detrimental agents had changed chemically, had removed during the combustion, and bound to the granular structure, whereby from an environmental standpoint, a neutral product was obtained.

The size of the granules formed varied in the range 5-25 mm. The specific weight of the granules varied in the range 0.3-1.5.

From the solubility tests it was observed that the solubility of different agents and metals was below the limits set by the authorities.

In addition, it was found that barium sulphate had transformed into non-detrimental barium and sulphur compounds during the process, which was an additional advantage for it invention.

In addition, combustion gas emissions were low, and different components were well within the limits. The dwell time was observed to have an effect on the composition of the combustion gases.

In addition, a test run was run near the melting point for samples A50B50, A0, and A00. Then, a temperature of about 1180° C. was found to be suitable, at which temperature suitable adherence properties are achieved for the granules.

As a summation of the tests one can see that with different mixture ratios of oil drilling waste, recyclable, compact-coated granules which are non-detrimental to the environment were obtained. In addition, it was observed that burning the hydrocarbons, contained in oil drilling waste, in the kiln reduced the need for external heating energy.

In the form of various embodiments, the method and apparatus of the invention are suited to be used in the processing of various kinds of drilling waste.

The embodiments of the invention are not limited to the examples presented above, but they can vary within the scope of the attached claims.

1. A method for processing oil drilling waste, wherein oil drilling waste of one or more types is selected, which waste is introduced into a rotating kiln; and in the kiln, the oil drilling waste is processed at a temperature of 1100 to 1350° C. to form granules having a compact-coated surface.

2. The method as defined in claim 1, wherein the oil drilling waste is mixed to form a homogenous mixture prior to introduction into the rotating kiln.

3. The method as defined in claim 1, wherein in the kiln, the oil drilling waste is processed at a temperature of 1120 to 1200° C.

4. The method as defined in claim 3, wherein in the kiln, the oil drilling waste is processed at a temperature of 1130 to 115O° C.

5. The method as defined in claim 3, wherein in the kiln, the oil drilling waste is processed at a temperature of more than 1150° C. to add to the adherence of the granules to one another.

6. The method as defined in claim 1, wherein clay-based material is added to the oil drilling waste.

7. The method as defined in claim 1, wherein sand material is added to the oil drilling material.

8. The method as defined in claim 1, wherein water is added to the oil drilling waste.

9. The method as defined in claim 1, wherein the water is removed from the oil drilling waste prior to the rotating kiln.

10. The method as defined in claim 1, wherein in the method, the mixture ratio and/or additives of different types of oil drilling waste is adjusted.

11. The method as defined in claim 1, wherein the specific weight of the granules produced as a product is adjusted to be in the range 0.3-1.5 by changing the mixture ratio of different types of oil drilling waste.

12. An apparatus for processing oil drilling waste, wherein the apparatus includes one or more feeding tanks; a rotating kiln, into which the oil drilling waste from the feeding tanks is introduced, and in which it is processed at a temperature of 1100 to 1350° C. to form compact-coated granules; and a storage tank, into which the product from the kiln is stored; with the feeding tank, the kiln and the storage tank being connected to form one whole.

13. The apparatus as defined in claim 12, wherein the apparatus in-eludes a mixing device for mixing the oil drilling waste from the feeding tank to form a homogenous mixture.

14. The apparatus as defined in claim 12, that wherein the apparatus in-eludes at least one pump for pumping the oil drilling waste.

15. The apparatus as defined in claim 12, wherein the apparatus includes at least one conveyor for conveying the oil drilling waste from one part of the apparatus to another.

16. The apparatus as defined in claim 12, wherein the apparatus is moveable.

17. The apparatus as defined in claim 12, wherein the apparatus is integrated in conjunction with a vessel.
